(19) United States
(12) Patent Application Publication
(10) Pub. No.: US 2026/0012386 A1
(43) Pub. Date: Jan. 8, 2026

(54) ABNORMALITY MONITORING METHOD, ABNORMALITY MONITORING SYSTEM, AND NON-TRANSITORY RECORDING MEDIUM

(71) Applicant: Panasonic Projector & Display Corporation, Osaka (JP)

(72) Inventor: Koji SASAKI, Osaka (JP)

(21) Appl. No.: 19/327,010

(22) Filed: Sep. 12, 2025

Related U.S. Application Data
(63) Continuation of application No. PCT/JP2024/008121, filed on Mar. 4, 2024.

(30) Foreign Application Priority Data
Mar. 14, 2023 (JP) 2023-039859

(51) Int. Cl. H04L 41/06; H04L 43/0888

(52) U.S. Cl. CPC H04L 41/06; H04L 43/0888

(57) ABSTRACT

An abnormality monitoring method is a method for monitoring communication states of a plurality of terminals using a monitoring device connected to a network, the abnormality monitoring method including transmitting requests respectively to the plurality of terminals, receiving responses to the requests, calculating a throughput of the network based on transmission of the requests and reception of the responses, making a first determination of determining whether the communication states of the plurality of terminals are abnormal, based on the throughput, sizes of the requests transmitted respectively to the plurality of terminals, and any one or more of transfer speeds, packet losses, and numbers of retransmission packets in the received responses, making a second determination of determining whether an abnormality has occurred on communication paths between the monitoring device and the plurality of terminals, based on a result of the first determination, and outputting a result of the second determination.

### CROSS REFERENCE TO RELATED APPLICATION

This application claims benefit of priority to Japanese Patent Application 2023-039859, filed Mar. 14, 2023, the entire content of which is incorporated herein by reference.

### BACKGROUND

### Technical Field

The present disclosure relates to an abnormality monitoring method and an abnormality monitoring system for monitoring whether an abnormality has occurred in a plurality of terminals and a network where the plurality of terminals is installed. The present disclosure further relates to a non-transitory recording medium storing a program for causing a computer to execute the abnormality monitoring method.

### Background Art

Japanese Unexamined Patent Application Publication No. 2003-244146 discloses a display device that accumulates performance information about a transmission device connected to a network and displays moving images of time-series information based on the accumulated performance information to determine a quality state of the network.

### SUMMARY

The conventional technique as in Japanese Unexamined Patent Application Publication No. 2003-244146 has a problem that it takes time to specify whether a failure has occurred in a client terminal itself or a failure has occurred in the network between a server and the client terminal.

The present disclosure provides an abnormality monitoring method and the like that enable a user to easily specify whether an abnormality has occurred in a terminal to be monitored or an abnormality has occurred in a network.

An abnormality monitoring method according to one aspect of the present disclosure is an abnormality monitoring method for monitoring communication states of a plurality of terminals connected to a network via one or more relay devices by using a monitoring device connected to the network, the abnormality monitoring method including transmitting requests respectively to the plurality of terminals, receiving responses to the requests, calculating a throughput of the network based on transmission of the requests and reception of the responses, making a first determination of determining whether the communication states of the plurality of terminals are abnormal, based on the throughput, sizes of the requests transmitted respectively to the plurality of terminals, and any one or more of transfer speeds, packet losses, and numbers of retransmission packets in the received responses, making a second determination of determining whether an abnormality has occurred on communication paths between the monitoring device and the plurality of terminals, based on a result of the first determination, and outputting a result of the second determination.

Further, an abnormality monitoring system according to one aspect of the present disclosure is an abnormality monitoring system including a plurality of terminals connected to a network via one or more relay devices, and a monitoring device that is connected to the network and monitors communication states of the plurality of terminals. The monitoring device transmits requests respectively to the plurality of terminals, receives responses to the requests, calculates a throughput of the network based on transmission of the requests and reception of the responses, makes a first determination of determining whether the communication states of the plurality of terminals are abnormal, based on the throughput, sizes of the requests transmitted respectively to the plurality of terminals, and any one or more of transfer speeds, packet losses, and numbers of retransmission packets in the received responses, makes a second determination of determining whether an abnormality has occurred on communication paths between the monitoring device and the plurality of terminals, based on a result of the first determination, and outputs a result of the second determination.

Furthermore, an abnormality monitoring method according to another aspect of the present disclosure is an abnormality monitoring method for monitoring communication states of a plurality of terminals connected to a network via one or more relay devices by using a monitoring device connected to the network, the abnormality monitoring method including transmitting requests respectively to the plurality of terminals, receiving responses to the requests, making a first determination of determining whether the communication states of the plurality of terminals are abnormal, based on transmission of the requests or reception of the responses, making a second determination of determining whether an abnormality has occurred on communication paths between the monitoring device and the plurality of terminals, and outputting a result of the second determination.

Note that these general or specific aspects may be implemented by a device, an integrated circuit, a computer program, or a non-transitory recording medium such as a computer-readable CD-ROM, or may be implemented by any combination of a method, a system, a device, an integrated circuit, a computer program, and a non-transitory recording medium.

The monitoring method and the like of the present disclosure enable a user to easily specify whether an abnormality has occurred in a terminal to be monitored or in a network.

### BRIEF DESCRIPTION OF DRAWINGS

FIG. 1 is a block diagram illustrating an example of a configuration of an abnormality monitoring system according to an embodiment.

FIG. 2 is a block diagram illustrating an example of a configuration of a terminal according to the embodiment.

FIG. 3 is a table for explaining request types.

FIG. 4 is a table showing group management information.

FIG. 5 is a schematic diagram for describing a connection state at a time when a plurality of terminals installed on a network is managed in a group.

FIG. 6 is a flowchart showing an example of processing for generating path information about the plurality of terminals.

FIG. 7 is a table for explaining generated new path information.

FIG. 8 is a sequence chart showing an example of an operation of the abnormality monitoring system according to the embodiment.

FIG. 9 is a table showing an example of response times of the terminals and determinations using the response times.

FIG. 10 is a table showing an example of information about communication information indicating a network communication state of a monitoring device.

FIG. 11 is a table showing an example of determination results (results of a first determination) on whether the communication states of the terminals are abnormal.

FIG. 12 is a table showing an example of determination results (results of a second determination) on whether an abnormality has occurred on the communication paths.

FIG. 13 is a diagram illustrating an example of abnormality information.

FIG. 14 is a block diagram illustrating an example of a system configuration after reconstruction of a network configuration.

### DETAILED DESCRIPTION

### (Knowledge Underlying the Present Disclosure)

The present inventor has found that the following problems arise in a conventional system described in the section of “BACKGROUND ART”.

In the conventional technique, in a monitoring system that monitors a plurality of terminals installed on one network, communication states of terminals to be monitored are periodically acquired, and occurrence of an abnormality in those terminals is detected based on the communication states. The plurality of terminals to be monitored in such a monitoring system often includes terminals connected via a plurality of network connection devices (network hubs, routers, etc.). Further, many communication devices may be connected on the network in addition to the terminals to be monitored, which may affect the communication states of the terminals to be monitored. For this reason, when the communication states affected by an abnormality occurring in other communication devices are acquired, an erroneous detection might be made that an abnormality has occurred in terminals although no abnormality has occurred in the terminals. Further, it is difficult to specify a cause that affects the communication states of the terminals.

Therefore, the present inventor has found an abnormality monitoring method and the like that enable a user to easily specify whether an abnormality has occurred in terminals to be monitored or on a network.

An abnormality monitoring method according to a first aspect of the present disclosure is an abnormality monitoring method for monitoring communication states of a plurality of terminals connected to a network via one or more relay devices by using a monitoring device connected to the network, the abnormality monitoring method including transmitting requests respectively to the plurality of terminals, receiving responses to the requests, calculating a throughput of the network based on transmission of the requests and reception of the responses, making a first determination of determining whether the communication states of the plurality of terminals are abnormal, based on the throughput, sizes of the requests transmitted respectively to the plurality of terminals, and any one or more of transfer speeds, packet losses, and numbers of retransmission packets in the received responses, making a second determination of determining whether an abnormality has occurred on communication paths between the monitoring device and the plurality of terminals, based on a result of the first determination, and outputting a result of the second determination.

Accordingly, the first determination is made based on the throughput, the sizes of the requests transmitted respectively to the plurality of terminals, and any one or more of the transfer speeds, the packet losses, and the numbers of retransmission packets in the received responses, and a determination is made whether an abnormality has occurred on communication paths, based on the result of the first determination. For this reason, a determination can be made more accurately whether an abnormality has occurred in terminals to be monitored or on a network.

An abnormality monitoring method according to a second aspect of the present disclosure is the abnormality monitoring method according to the first aspect, where in the first determination, for each of the plurality of terminals, a communication processing time required for communication processing of a packet per unit size in each terminal is estimated based on the throughput, the size of the request transmitted to each terminal, and any one or more of the transfer speed, the packet loss, and the number of retransmission packets in the response received from each terminal, and in a case where the estimated communication processing time exceeds a predetermined threshold corresponding to each terminal, a determination is made that the communication state of each terminal is abnormal.

Therefore, the determination can be made more accurately whether the communication states of the terminals are abnormal.

An abnormality monitoring method according to a third aspect of the present disclosure is the abnormality monitoring method according to the first or second aspect in which the plurality of responses received by the monitoring device respectively from the plurality of terminals includes one or more pieces of device information indicating one or more communication devices on the network, the responses having passed through the one or more communication devices between the plurality of terminals that has respectively transmitted the responses and the monitoring device, and wherein the plurality of communication paths between the monitoring device and the plurality of terminals is specified based on the one or more pieces of device information included in the responses transmitted respectively from the plurality of terminals respectively corresponding to the communication paths.

Accordingly, the communication paths between one or more terminals that have transmitted one or more responses and the monitoring device are specified based on one or more pieces of device information included in the one or more responses. For this reason, for example, the communication paths where an abnormality has occurred can be specified by determining whether an abnormality has occurred in the one or more communication devices.

An abnormality monitoring method according to a fourth aspect of the present disclosure is the abnormality monitoring method according to any one of the first to third aspects in which the plurality of terminals is classified into one or more groups, the abnormality monitoring method further including, for each of the plurality of terminals, acquiring, based on the response received from each terminal, first path information including a combination of one or more pieces of device information indicating one or more devices between the monitoring device and each terminal, generating, in a case where the one or more pieces of device information included in the first path information does not include a first device information indicating a first device common to one or more terminals belonging to the group to which each terminal belongs, second path information in which the first device information is added to the one or more pieces of device information, and making, in the second determination, a determination whether an abnormality has occurred on the communication path based on the second path information.

Therefore, even in a case where the monitoring device is connected to the terminals via a relay device that is commonly connected to the plurality of terminals, a determination can be made whether an abnormality has occurred on the communication paths routed through the relay device. In this relay device, the information from the terminals includes no information routed through the relay device.

An abnormality monitoring method according to a fifth aspect of the present disclosure is the abnormality monitoring method according to any one of the first to fourth aspects in which the plurality of terminals includes a plurality of first terminals belonging to a first group and one or more second terminals belonging to a second group, the abnormality monitoring method further including making a determination that an abnormality has occurred on communication paths routed through a first relay device that relays communication between the monitoring device and the plurality of first terminals in a case where a determination is made in the second determination that an abnormality has occurred in all of the plurality of first terminals.

Therefore, a determination can be made whether an abnormality has occurred on the communication paths routed through the first relay device.

An abnormality monitoring method according to a sixth aspect of the present disclosure is the abnormality monitoring method according to the fifth aspect further including determining whether communication states of the plurality of first terminals are similar to each other, based on the sizes of the requests transmitted respectively to the plurality of terminals and any one of the transfer speeds, the packet losses, and the numbers of retransmission packets in the received responses, and excluding a third terminal from the first group in a case where the plurality of first terminals includes the third terminal having a dissimilar communication state.

For example, in a case where the plurality of first terminals is classified into the same group based on connection by the common relay device, a third terminal that has been erroneously classified can be excluded from the group by using the fact that the communication states of the plurality of first terminals are similar.

An abnormality monitoring method according to a seventh aspect of the present disclosure is the abnormality monitoring method according to any one of the first to sixth aspects in which in the result of the second determination, one or more abnormal terminals where an abnormality has occurred are indicated in a display mode different from that of other terminals where no abnormality has occurred.

Therefore, a user can distinguish and visually recognize a terminal where an abnormality has occurred and a terminal where no abnormality has occurred. Further, the user can distinguish and visually recognize a communication path where an abnormality has occurred and a communication path where no abnormality has occurred.

An abnormality monitoring system according to an eighth aspect of the present disclosure is an abnormality monitoring system including a plurality of terminals connected to a network via one or more relay devices, and a monitoring device that is connected to the network and monitors communication states of the plurality of terminals. The monitoring device transmits requests respectively to the plurality of terminals, receives responses to the requests, calculates a throughput of the network based on transmission of the request and reception of the response, makes a first determination of determining whether the communication states of the plurality of terminals are abnormal, based on the throughput, a size of the request transmitted to each of the plurality of terminals, and any one or more of transfer speeds, packet losses, and numbers of retransmission packets in the received responses, makes a second determination of determining whether an abnormality has occurred on communication paths between the monitoring device and the plurality of terminals, based on a result of the first determination, and outputs a result of the second determination.

Accordingly, the first determination is made based on the throughput, the sizes of the requests transmitted respectively to the plurality of terminals, and any one or more of the transfer speeds, the packet losses, and the numbers of retransmission packets in the received responses, and a determination is made whether an abnormality has occurred on communication paths, based on the result of the first determination. For this reason, a determination can be made more accurately whether an abnormality has occurred in terminals to be monitored or on a network.

A non-transitory recording medium according to a ninth aspect of the present disclosure is a non-transitory recording medium storing a program for causing a computer to execute the abnormality monitoring method according to any one of the first to seventh aspects.

An abnormality monitoring method according to a tenth aspect of the present disclosure is an abnormality monitoring method for monitoring communication states of a plurality of terminals connected to a network via one or more relay devices by using a monitoring device connected to the network, the abnormality monitoring method including transmitting requests respectively to the plurality of terminals, receiving responses to the requests, making a first determination of determining whether the communication states of the plurality of terminals are abnormal, based on transmission of the requests or reception of the responses, making a second determination of determining whether an abnormality has occurred on communication paths between the monitoring device and the plurality of terminals, and outputting a result of the second determination.

A non-transitory recording medium according to an eleventh aspect of the present disclosure is a non-transitory recording medium storing a program for causing a computer to execute the abnormality monitoring method according to tenth aspect.

Note that these general or specific aspects may be implemented by a device, an integrated circuit, a computer program, or a non-transitory recording medium such as a computer-readable CD-ROM, or may be implemented by any combination of a method, a system, a device, an integrated circuit, a computer program, and a non-transitory recording medium.

Hereinafter, embodiments will be described in detail with reference to the drawings as appropriate. However, more detailed description than necessary may be omitted. For example, detailed descriptions of already well-known matters and duplicate descriptions for substantially the same configuration may be omitted. This is to avoid unnecessary redundancy of the following description and to facilitate the understanding by those skilled in the art.

Note that the accompanying drawings and the following description are provided in order that those skilled in the art fully understand the present disclosure, and do not intend to limit the subject matter described in the claims.

### Embodiment

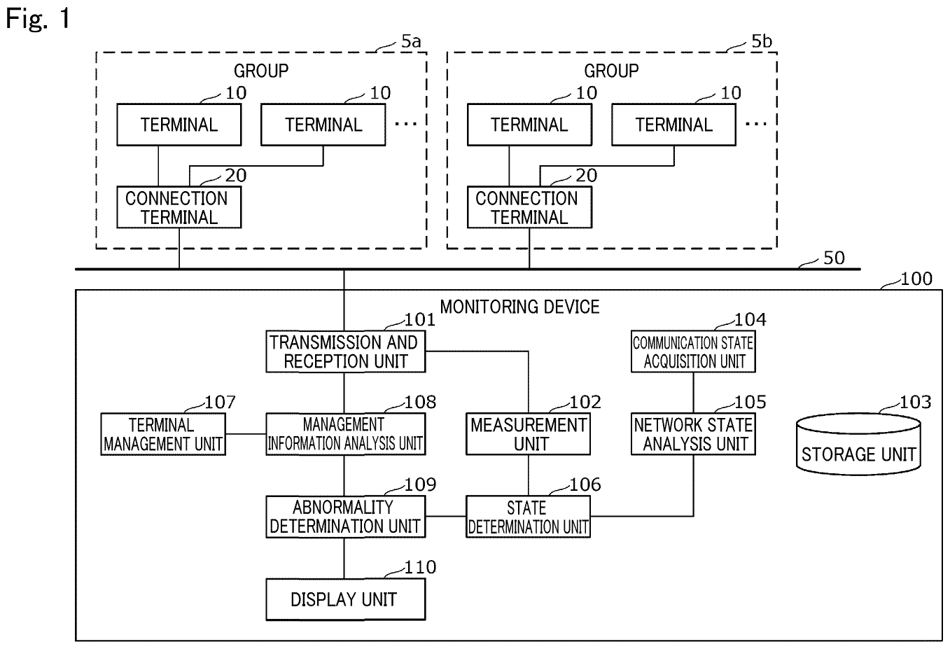

Hereinafter, an embodiment will be described with reference to FIGS. 1 to 14.

### 1-1. Configuration

### 1-1-1. Configuration of Abnormality Monitoring System

FIG. 1 is a block diagram illustrating an example of a configuration of the abnormality monitoring system according to the embodiment.

The abnormality monitoring system includes a plurality of terminals 10 and a monitoring device 100. The plurality of terminals 10 is connected to a network 50 via a connection terminal 20. In this manner, the plurality of terminals 10 and the monitoring device 100 are communicably connected via the network 50.

The plurality of terminals 10 includes a plurality of terminals 10 belonging to a group 5a and a plurality of terminals 10 belonging to a group 5b. The plurality of terminals 10 belonging to the group 5a is connected to the network 50 via the connection terminal 20 common to the plurality of terminals 10 belonging to the group 5a. The plurality of terminals 10 belonging to the group 5b is connected to the network 50 via the connection terminal 20 common to the plurality of terminals 10 belonging to the group 5b. Note that the number of the terminals 10 belonging to each group may be one. The connection terminal 20 connected to the plurality of terminals 10 belonging to the group 5a is different from the connection terminal 20 connected to the plurality of terminals 10 belonging to the group 5b.

The states of the plurality of terminals 10 are monitored by the monitoring device 100. That is, the plurality of terminals 10 are terminals to be monitored by the monitoring device 100. Each of the plurality of terminals 10 may be implemented by, for example, a display terminal such as a liquid crystal display, an organic electroluminescence (EL) display, or a projector, or may be implemented by an imaging terminal such as a camera.

The monitoring device 100 is a device that monitors the states of the plurality of terminals 10. Further, the monitoring device 100 is a device that monitors the communication states of a plurality of communication paths between the monitoring device 100 and the plurality of terminals 10. The monitoring device 100 transmits requests respectively to the plurality of terminals 10, and receives one or more responses respectively transmitted by one or more terminals 10 among the plurality of terminals 10 in response to the transmitted requests. The monitoring device 100 then acquires the states of the plurality of terminals 10 and the communication states of the plurality of communication paths between the monitoring device 100 and the plurality of terminals 10, based on the received one or more responses. In a case where the monitoring device 100 determines, based on the communication states of the plurality of terminals 10 and the communication states of the plurality of communication paths, that an abnormality has occurred in at least one of one or more of the plurality of terminals 10 and one or more of the plurality of communication paths, the monitoring device 100 generates abnormality information indicating at least one of the one or more terminals 10 and the one or more communication paths where the abnormality has occurred, and presents the generated abnormality information. The monitoring device 100 may be implemented by, for example, an information processing device such as a personal computer (PC).

Each of the plurality of connection terminals 20 is implemented by a network hub, a router, or the like. The connection terminal 20 is an example of a relay device that relays communication between the monitoring device 100 and the terminals 10.

The network 50 may be a general-purpose network such as the Internet or a dedicated network.

### 1-1-2. Configuration of Terminal

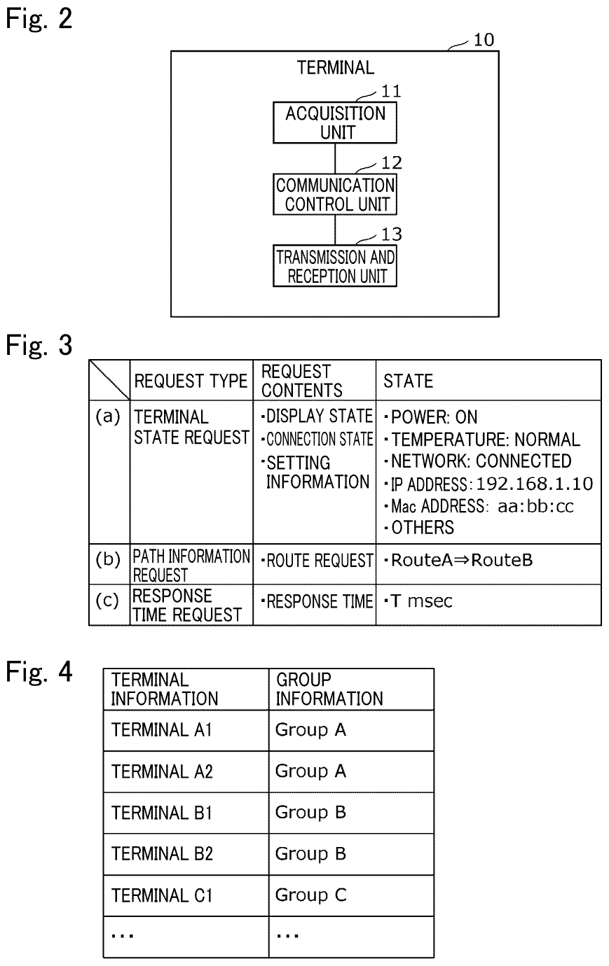

Next, configurations of the plurality of terminals 10 will be described with reference to FIG. 2. Since the configurations of the plurality of terminals 10 are common, the configuration of one terminal 10 will be described. FIG. 2 is a block diagram illustrating an example of the configuration of the terminal according to the embodiment.

The terminal 10 includes an acquisition unit 11, a communication control unit 12, and a transmission and reception unit 13. The transmission and reception unit 13 receives a request transmitted from the monitoring device 100. The communication control unit 12 analyzes the request received by the transmission and reception unit 13. The acquisition unit 11 acquires various types of information requested in the received request, based on an analysis result of the request by the communication control unit 12. Further, the acquisition unit 11 acquires measurement information by measuring the communication state at the time of receiving the request. The measurement information includes communication traffic, a network communication state, and the like. The measurement information may further include the number of retransmission times of a response to the request by the terminal 10 as a measurement value. The measurement information may further include the number of errors caused in the transmission of the response to the request by the terminal 10 as a measurement value.

Every time the acquisition unit 11 measures the communication state, the communication control unit 12 may accumulate the measured communication state in a storage device, not illustrated, included in the terminal 10. The transmission and reception unit 13 transmits a response including various types of information and the measurement information acquired by the acquisition unit 11 to the monitoring device 100 as the response to the received request.

Note that each component included in the terminal 10 may be implemented by dedicated hardware or by executing a software program suitable respectively for the components. Each component may be implemented by a program execution unit such as a central processing unit (CPU) or a processor reading and executing a software program recorded in a recording medium such as a hard disk or a semiconductor memory.

### 1-1-3. Configuration of Monitoring Device

Returning to FIG. 1, the configuration of the monitoring device 100 will be described.

The monitoring device 100 includes a transmission and reception unit 101, a measurement unit 102, a storage unit 103, a communication state acquisition unit 104, a network state analysis unit 105, a state determination unit 106, a terminal management unit 107, a management information analysis unit 108, an abnormality determination unit 109, and a display unit 110.

The transmission and reception unit 101 exchanges information with the plurality of terminals 10 connected to the network. Specifically, the transmission and reception unit 101 transmits a request for acquiring state information including the operation states of the terminals 10 to the plurality of terminals 10. The transmission and reception unit 101 then receives, from the plurality of terminals 10, a plurality of responses transmitted based on the reception of the requests from the plurality of terminals 10. The plurality of responses respectively includes the operation states of the plurality of terminals 10. Note that the plurality of responses is not necessarily transmitted from all of the plurality of terminals 10, and no response might be transmitted from some of the terminals 10 in a case where a failure has occurred in some of the terminals 10 or in a case where a failure has occurred on the communication paths. That is, the monitoring device 100 may receive all of the plurality of responses, or may receive only some of the plurality of responses or only one response.

Further, each of the plurality of responses received by the monitoring device 100 includes terminal information on the terminal 10 that has transmitted the response and one or more pieces of device information. The terminal information includes individual setting information such as an internet protocol (IP) address of the terminal 10 that has transmitted the response including the terminal information. Further, the terminal information may further include group information for identifying a group to which the terminal 10 belongs. Each of the one or more pieces of device information indicates the one or more communication devices on the network. The response including the device information passes through the one or more communication devices between the terminal 10 that has transmitted the response and the monitoring device 100. The one or more communication devices include, for example, the connection terminal 20 for connecting the terminal 10 to the network 50. Each of the one or more pieces of device information may be any information that enables the one or more communication devices to be identified. Each of the plurality of responses may further include measurement information.

FIG. 3 is a table for explaining request types. The requests may be periodically generated and transmitted respectively to the plurality of terminals 10, or may be transmitted respectively to the plurality of terminals 10 upon reception of predetermined information.

As illustrated in FIG. 3, the requests respectively include terminal state requests for requesting the monitoring target terminals 10 to transmit the states of these terminals 10, path information requests for requesting path information, communication state requests for requesting transmission of the communication states of the terminals 10, and the like. The states of the terminals 10 requested in the terminal state requests include an operating state, a display state, a connection state, setting information, and the like, and specifically include a power on-off state, a temperature, a state of the connection to the network, an IP address, a media access control (MAC) address, and the like. Other included information is warning information and error information indicating abnormality of the terminals 10 in a stepwise manner. The warning information and the error information may be presented when an intake air temperature of a cooling fan of each of the terminals 10, an amount of dust sucked by the cooling fan, or the like exceeds a threshold Th_f. That is, in a case where the intake air temperature of the cooling fan of the terminal 10, the amount of dust sucked by the cooling fan, or the like exceeds the threshold Th_f, a determination may be made that an abnormality has occurred in the terminal 10. The threshold Th_f may include a threshold Th_f1 as a trigger for generating the warning information and a threshold Th_f2 greater than the threshold Th_f1 as a trigger for generating the error information. The path information requested in the path information request includes, for example, a route request, and indicates that information is exchanged through a route A via a router A and a route B via a router B. The communication state requested in the communication state request (response time request) is, for example, a time from when the monitoring device 100 issues any transmission request to the terminal 10 to when the monitoring device 100 receives a response to the transmission request from the terminal 10.

Note that, as for each of the one or more received responses, the measurement unit 102 may measure, as a response time of each terminal 10, a time from a first time to a second time. At the first time, a request for the response is transmitted to each of the plurality of terminals 10 via the transmission and reception unit 101. At the second time, the response is received. The measurement unit 102 may then generate measurement information including the response time obtained by the measurement as a measurement value. The measurement unit 102 may further generate measurement information including the number of times of retransmission of the request from the monitoring device 100 to each terminal 10 as the measurement value. The measurement unit 102 may further generate measurement information including the number of errors caused in the transmission of the request from the monitoring device 100 to each terminal 10 as the measurement value.

Further, the measurement unit 102 may associate terminal information about the terminal 10 corresponding to the generated measurement information with the measurement information. The measurement value included in the measurement information correlates with the evaluation of communication quality between the monitoring device 100 and the terminal 10 that has transmitted the response including the measurement information including the measurement value or the response from which the measurement information including the measurement value is generated. For example, a longer response time indicates lower communication quality. A larger number of response or request retransmission times indicates lower communication quality. A larger number of errors indicates lower communication quality.

Further, in a case where responses cannot be received respectively from all of the plurality of terminals 10, that is, in a case where the number of one or more terminals 10 corresponding to one or more responses is smaller than the number of all the plurality of terminals 10, the measurement unit 102 may generate measurement information about one or more other terminals 10 from which a response cannot be received as follows. That is, the one or more pieces of measurement information about the one or more other terminals 10 may be generated when the monitoring device 100 fails to receive the one or more other responses to the requests from the one or more other terminals 10 within a predetermined period. Furthermore, the one or more pieces of measurement information may indicate that the communication quality is lower than the communication quality of the one or more measurement values acquired in accordance with the received one or more responses.

Further, as for each of the one or more responses received by the transmission and reception unit 101, the measurement unit 102 acquires terminal information included in the response, that is, terminal information about the terminal 10 that has transmitted the response and one or more pieces of device information, and stores, in the storage unit 103, a data set of the terminal information acquired in each response and the one or more pieces of device information.

Note that the measurement unit 102 may read N (N is an integer of 2 or more) response times obtained during a predetermined period from the storage unit 103, and calculate an average response time that is an average of the plurality of response times. The predetermined period may be, for example, a period from the latest timing of measuring the response time to the timing before a predetermined time. The N response times may be N response times selected in descending order of measured timing among the plurality of response times stored in the storage unit 103. The calculated average response times are stored in the storage unit 103 with them being distinguishable for the respective terminals 10. That is, identifiers for identifying the terminals 10 and the average response times of the terminals 10 are stored in the storage unit 103 in association with each other. Note that, since the response time is a time affected by the communication processing of each terminal 10, it can also be a communication processing time of each terminal 10.

The communication state acquisition unit 104 monitors the operation state of the processor of the monitoring device 100 or the operation state of the transmission and reception unit 101 to acquire communication information about the communication state of the monitoring device 100. The communication information includes a load state of the monitoring device 100 (CPU), device information (Device), a communication speed (Speed), the number of transmission packets (Send), the number of reception packets (Recv), the number of collision packets (Collision), the number of lost packets (Lost), the number of retransmission packets (Retry), and the like.

The network state analysis unit 105 calculates a throughput indicating a maximum data transfer amount per unit time in the monitoring device 100 depending on the current communication state of the monitoring device 100, based on the capacity (size) and the response time of the request transmitted to each terminal 10 and the communication information. The network state analysis unit 105 calculates a throughput in each terminal 10 based on the calculated throughput, the capacity (size) and the response time of the request transmitted to each terminal 10, and the communication information, and determines, for each terminal 10, a threshold Th_a for determining the communication state of each terminal 10 based on the calculated throughput. The network state analysis unit 105 may estimate the response time required for each terminal 10 responding to the request based on the current communication quality of the network based on the throughput, the operation state of each terminal 10, and the size of the request transmitted to acquire the operation state of each terminal 10, thereby estimating the communication processing time (communication speed) required for the communication processing of a packet per unit size. The network state analysis unit 105 may then determine the threshold value Th_a based on the estimated communication processing time. The network state analysis unit 105 may determine the estimated response time itself as the threshold Th_a, or may determine, as the threshold Th_a, a value obtained by increasing or decreasing the estimated response time by a predetermined rate. The predetermined rate may be associated in advance depending on the operation state of each terminal 10.

For each of the plurality of terminals 10, the state determination unit 106 compares the response time of the terminal 10, the response time being measured by the measurement unit 102, with the threshold Th_a of the terminal 10, the threshold being determined by the network state analysis unit 105. The state determination unit 106 determines that the communication state of the terminal 10 having a response time exceeding the threshold Th_a is abnormal. Further, the state determination unit 106 determines that the communication state of the terminal 10 having a response time equal to or less than the threshold Th_a is normal.

Note that the threshold Th_a may include a threshold Th_a1 as a trigger for generating warning information and a threshold Th_a2 greater than the threshold Th_a1 as a trigger for generating error information. In this case, the state determination unit 106 determines that the communication state of the terminal 10 having response time exceeding the threshold Th_a1 and equal to or less than the threshold Th_a2 is a warning state, and determines that the communication state of the terminal 10 having a response time exceeding the threshold Th_a2 is abnormal. The state determination unit 106 determines that the communication state of the terminal 10 having a response time equal to or less than the threshold Th_a1 is normal.

In this manner, the network state analysis unit 105 and the state determination unit 106 make the first determination of determining whether the communication states of the plurality of terminals 10 are abnormal, based on the throughput, the sizes of the requests transmitted respectively to the plurality of terminals 10, and any one or more of the transfer speeds, the packet losses, and the numbers of retransmission packets in the received responses.

A specific example of communication state determination processing will be described below.

For example, assuming that the communication speed (theoretical speed) of the monitoring device 100 is 1 Gbps (125 MB/s) and the effective speed is 50% of the communication speed, the effective speed of the monitoring device 100 is calculated to be 62.5 MB/s. Since the effective speed of the monitoring device 100 is affected by the CPU usage rate and the memory (RAM) usage rate, the effective speed can be estimated as a value depending on the CPU usage rate and the memory (RAM) usage rate. For example, the CPU resource allocated to the communication processing of the monitoring device 100 is 80% of an available CPU resource, and the memory resource allocated to the communication processing of the monitoring device 100 is 20% of an available memory resource. In this case, the rate K % of the throughput of the monitoring device 100 with respect to the effective speed is calculated using the following formula.

$$K = ( ( 100 - CPU usage rate ) \times 0.8 ) + ( ( 100 - memory usage rate ) \times 0.2 ) \qquad Formula ( 1 )$$

Therefore, in a case where the CPU usage rate is 50% and the memory usage rate is 30%, K is calculated as 54%. Since the throughput Tp1 of the monitoring device 100 is a value of the rate K of 62.5 MB/s, the throughput Tp1 is calculated to be about 33 MB/s using the following Formula (2).

$$Tp 1 = effective speed \times K \qquad Formula ( 2 )$$

Since K is represented by a value larger than 0 and smaller than 100, it is found that the throughput Tp1 of the monitoring device 100 can be a value larger than 0 MB/s and smaller than 62.5 MB/s.

Note that when the CPU usage rate and the memory usage rate of the monitoring device 100 approach 100%, the effective speed of the monitoring device 100 approaches 0 MB/s.

In addition, the throughput of the monitoring device 100 may be calculated in consideration of the rate of defective packets with respect to the total number of transmission packets and reception packets (packet transmission and reception success rate). The defective packet is, for example, a collision packet, a lost packet, a retransmission packet, or the like. The transmission and reception success rate is calculated using, for example, the following Formula (3).

$$Transmission and reception success rate = ( 100 - ( ( number of collision packets \times k 1 + number of lost packets \times k 2 + number of retransmission packets \times k 3 ) / ( number of transmission packets + number of reception packets ) ) \times 100 ) \qquad Formula ( 3 )$$

Note that k1, k2, and k3 are weights determined based on the type of the defective packet (collision packet, lost packet, retransmission packet, and the like) and determined so as to be larger for a higher degree of the communication failure factor. In the initial setting, k1, k2, and k3 may be all set to 1, or the transmission and reception success rate may be calculated using the Formula (3) where k1, k2, and k3 are 1 without being weighted. A throughput Tp2 calculated in consideration of the transmission and reception success rate is calculated using, for example, the following Formula (4).

$$Tp 2 = Tp 1 \times transmission and reception success rate \qquad Formula ( 4 )$$

A threshold Th_m for determining the communication state of the monitoring device 100 may be set to a value of a first rate of the throughput Tp1 or the throughput Tp2 of the monitoring device 100. The first rate is, for example, 95%. The first rate is not limited to 95%, and may be set to a value included in the range between 90% and 99%. In a case where the throughput Tp1 or Tp2 of the monitoring device 100 is equal to or less than the threshold Th_m, a determination is made that the communication state of the monitoring device 100 is the warning state or the abnormal state, and the determination result may be notified.

Next, a method for calculating the communication speed of the connection terminal 20 will be described. A case where M (M is an integer of 1 or more) terminals 10 are connected to the connection terminal 20 will be described below.

First, the size of the request to each terminal 10 is different for each model of the terminal 10. Therefore, the size of the request is determined based on the device information about the terminal 10 that is the target for the request. The device information includes information for specifying the model of the terminal 10. Here, it is assumed that the average size of one request to the terminal 10 is, for example, 100 bytes. Further, for example, it is assumed that the average number of requests necessary for one terminal 10 is 300. That is, since 300 requests, each request being 100 Bytes, are transmitted to one terminal 10, the total information amount of the request to be transmitted to one terminal 10 is calculated using the following Formula (5).

$$Total information amount = average size of one request \times average number of requests to one terminal \qquad Formula ( 5 )$$

Therefore, the total information amount is calculated to be 30 KB (100 Bytes×300 requests).

Next, assuming that the average response time per request is 100 msec, the total response time required for transmitting and receiving 300 requests is calculated using the following Formula (6).

$$Total response time = average response time \times number of requests to one terminal \qquad Formula ( 6 )$$

Therefore, the total response time is calculated to be 30 sec (100 msec×300 requests).

Then, the communication speed necessary for acquiring the information about one terminal 10 is calculated using the following Formula (7).

$$Communication speed related to one terminal = total information amount / total response time \qquad Formula ( 7 )$$

Therefore, the communication speed related to one terminal is calculated to be 1 KB/s (=30 KB/30 sec).

The communication speed necessary for acquiring the information about the M terminals 10 is calculated using the following Formula (8).

$$Communication \times speed related to M terminals = communication speed related to one terminal \times M terminals \qquad Formula ( 8 )$$

Therefore, the communication speed related to the M terminals 10 is calculated as M KB/s (=1 KB/s×M).

The threshold Th_a for determining the communication state of the connection terminal 20 connected with the M terminals 10 may be set to a value of a second rate of the throughput Tp1 or the throughput Tp2 of the monitoring device 100. The second rate is, for example, 50%. The second rate is not limited to 50%, and may be set to a value included in a range between 45% and 55%. In a case where the communication speed of the connection terminal 20 is equal to or less than the threshold Th_a, a determination is made that the communication state of the connection terminal 20 is the warning state or the abnormal state. Then, the communication states of the M terminals 10 connected to the connection terminal 20 are determined to be communication states in accordance with the communication state of the connection terminal 20. For example, a determination may be made that the communication states of the M terminals 10 are the same as the communication state of the connection terminal 20. Further, the communication states of the M terminals 10 may be notified. In such a manner, a determination may be made whether the communication state of each terminal 10 is abnormal, in accordance with the communication state of the connection terminal 20. Note that, in a case where a determination is made that the communication states of N terminals 10 are the warning states, a user may decide to reconnect at least some of the N terminals 10 determined to be in the warning state from the connection terminal 20 to which the terminals 10 have been connected to another connection terminal 20. That is, in a case where the determination is made that the N terminals 10 are in the warning states, the user may change at least some of connection destinations of the N terminals 10 to another connection terminal 20.

As illustrated in FIG. 4, the terminal management unit 107 stores the terminal information in association with the group information. FIG. 4 is a table showing group management information. As a result, the terminal management unit 107 can store each data set in the storage unit 103 for each terminal information and for each group information. In a case where the one or more responses each include group information, the terminal management unit 107 may store each data set in the storage unit 103 for each group information based on the group information included in each of the one or more responses. The group information indicates a group where the plurality of terminals 10 is classified, and is generated based on an input from a user. The group management information illustrated in FIG. 4 is information including group information and a plurality of pieces of terminal information in association with each other. The plurality of pieces of terminal information indicates a plurality of terminals belonging to a group indicated by the group information.

The management information analysis unit 108 acquires a plurality of data sets from the transmission and reception unit 101, and specifies a communication path of each terminal 10 specified by the terminal information for each of the plurality of data sets, based on the terminal information and one or more pieces of device information included in each of the plurality of data sets. The communication path is specified by a combination of one or more pieces of device information included in the response transmitted from the terminal 10 corresponding to the communication path, that is, the terminal 10 specified by the terminal information. Further, the management information analysis unit 108 estimates that one or more terminals 10 belonging to each group are connected to the network 50 via the connection terminal 20 common to the one or more terminals 10, based on the group management information stored in the storage unit 103, and estimates a communication path routed through the connection terminal 20 as the communication path between the monitoring device 100 and each terminal 10. The management information analysis unit 108 then determines, for each terminal 10, whether the specified communication path is different from the estimated communication path, and in a case where they are different from each other, determines the estimated communication path as a new communication path between the monitoring device 100 and each terminal 10. In other words, in a case where the management information analysis unit 108 determines that the specified communication path does not include the device common to the one or more terminals 10 belonging to one group, the management information analysis unit 108 generates a communication path obtained by adding the common device to the specified communication path as a new communication path. The new path information indicating the determined new communication path is stored in the storage unit 103.

The abnormality determination unit 109 makes a second determination of determining whether an abnormality has occurred on the communication path between the monitoring device 100 and the plurality of terminals 10, based on the result of the first determination. Specifically, the abnormality determination unit 109 determines whether a communication abnormality has occurred in common in one or more terminals 10 belonging to each group. In a case where a determination is made that a communication abnormality has occurred in common in one or more terminals 10 belonging to each group, the abnormality determination unit 109 may determine that an abnormality has occurred in the connection terminal 20 provided in common in a group where the communication abnormality has occurred. That is, in a case where the state determination unit 106 determines that an abnormality has occurred in all of the plurality of first terminals belonging to the first group, the abnormality determination unit 109 determines that an abnormality has occurred on the communication path routed through the connection terminal 20 that relays communication between the monitoring device 100 and the plurality of first terminals. The abnormality determination unit 109 generates abnormality information including a determination result and outputs the abnormality information to the display unit 110.

The display unit 110 presents the abnormality information to the user by displaying the abnormality information generated by the abnormality determination unit 109. The display unit 110 is implemented by a liquid crystal display, an organic electroluminescence (EL) display, or the like.

Note that each component included in the monitoring device 100 may be implemented by dedicated hardware or by executing a software program suitable for each component. Each component may be implemented by a program execution unit such as a central processing unit (CPU) or a processor reading and executing a software program recorded in a recording medium such as a hard disk or a semiconductor memory.

### 1-2. Operation

An operation of the abnormality monitoring system configured as described above will be described.

First, a method for generating new path information will be described.

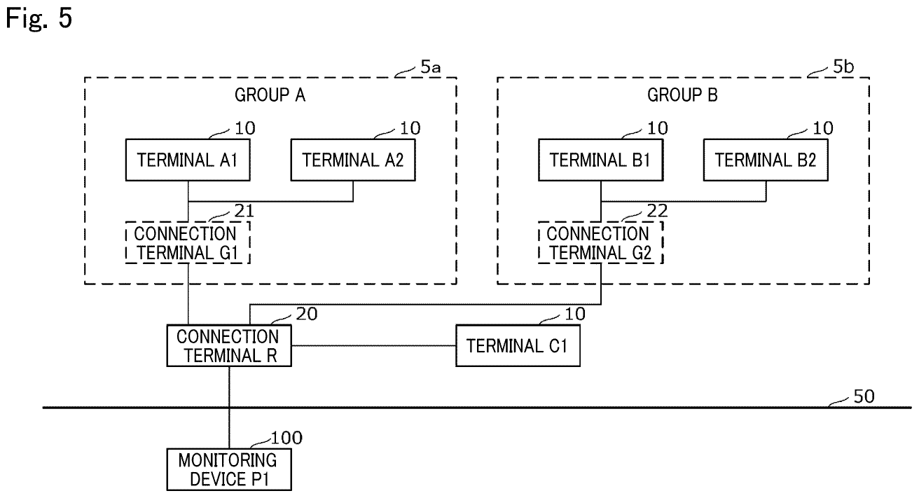

FIG. 5 is a schematic diagram for describing a connection state at a time the plurality of terminals installed on the network is managed in a group.

FIG. 5 illustrates that the monitoring device (P1) 100 and the connection terminal (R) 20 are connected to the network 50, and the terminals 10 (a terminal A1, a terminal A2, a terminal B1, a terminal B2, and a terminal C1) are connected to the connection terminal (R) 20. A connection terminal (G1) 21 and a connection terminal (G2) 22 are connected to the connection terminal (R) 20. Then, the terminal A1 and the terminal A2 are managed in group as a group A through the connection terminal (G1) 21. Further, the terminal B1 and the terminal B2 are managed in group as a group B through the connection terminal (G2) 22. The terminal C1 is directly connected to the connection terminal (R) 20 and is connected as a non-group management target.

The terminal management unit 107 manages the terminal information indicating the plurality of terminals A1, A2, B1, B2, and C1 by storing the terminal information in the storage unit 103. The terminal management unit 107 manages information about groups to which the terminals A1, A2, B1, B2, and C1 belong and unique information (IP address, model information, and the like) about the terminals A1, A2, B1, B2, and C1 by storing the information about groups as group management information together with the unique information.

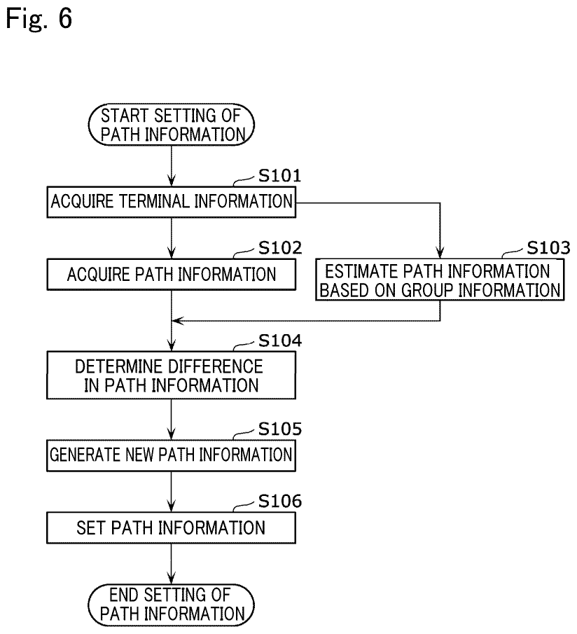

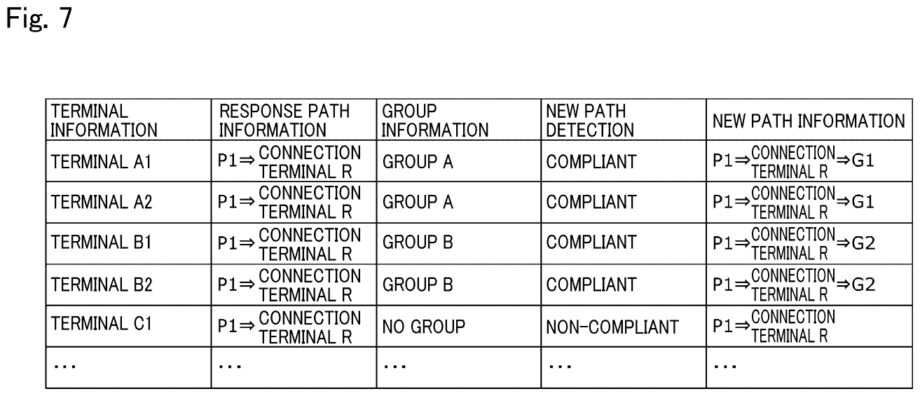

FIG. 6 is a flowchart showing an example of processing for generating path information about the plurality of terminals. FIG. 7 is a table for explaining generated new path information. FIG. 7 is a table for describing the new path information on the network configured as illustrated in FIG. 5.

The monitoring device 100 acquires the terminal information (IP address, model name, group management information, operation information, and the like) about each terminal 10, the terminal information being stored in the storage unit 103 (S101).

Next, the monitoring device 100 acquires the information about the path between the monitoring device (P1) 100 and the terminals 10 to be monitored by using the IP address included in the terminal information about the terminals 10 to be monitored (S102). For example, as illustrated in FIG. 7, the monitoring device 100 acquires “P1→connection terminal R” as the information about the path between the monitoring device 100 and the terminal A1.

Further, the monitoring device 100 acquires the group information associated with the acquired terminal information by referring to the group management information in the storage unit 103, estimates that the one or more terminals 10 belonging to each group are connected to the network 50 via the connection terminal 20 common to the one or more terminals 10, based on the group management information stored in the storage unit 103, and estimates the communication path routed through the connection terminal 20 as the communication path between the monitoring device 100 and each terminal 10 (S103). For example, the monitoring device 100 estimates “P1→connection terminal R→G1” as the path information between the monitoring device 100 and the terminal A1.

Next, the monitoring device 100 compares the path information acquired in step S102 with the path information estimated in step S103, and determines a difference between these pieces of the path information (S104). For example, the monitoring device 100 compares the path information “P1→connection terminal R” acquired in step S102 with the path information “P1→connection terminal R→G1” estimated in step S103, and determines that a difference exists therebetween. In this case, the monitoring device 100 determines that “→G1” is added to the path information estimated in step S103 in comparison with the path information acquired in step S102. That is, the monitoring device 100 estimates that the connection terminal G1 that does not appear on the path information acquired in step S102 is connected between the monitoring device 100 and the terminal A1. It is conceivable that the connection terminal G1 that does not appear on the path information acquired in step S102 is a hub that does not return a communication response, such as an unmanaged hub having a function of merely branching.

Next, the monitoring device 100 generates the path information estimated in step S103 as new path information (S105), and sets the new path information as the path information about each terminal (S106).

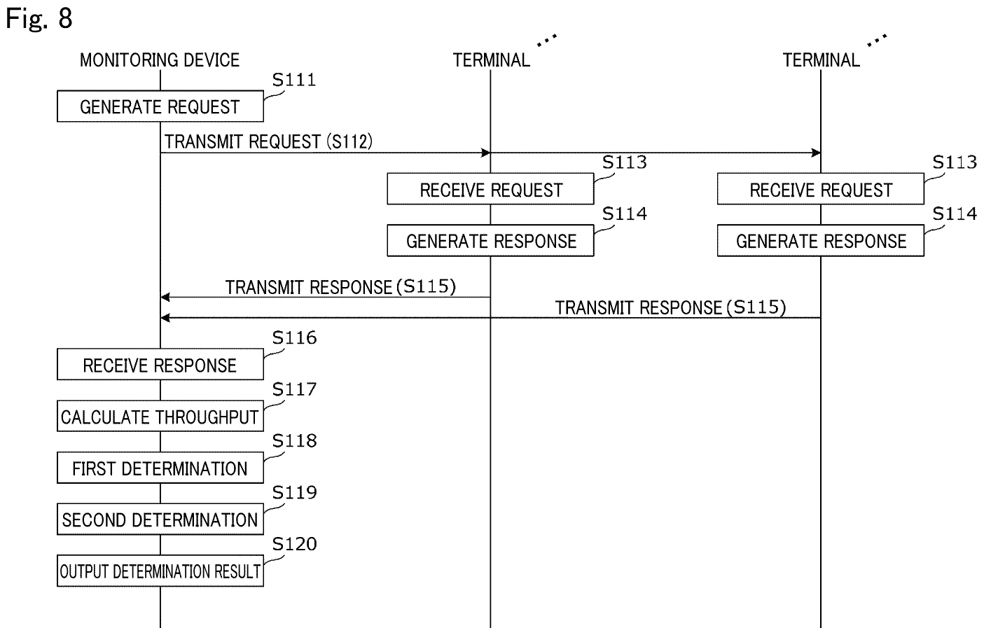

FIG. 8 is a sequence diagram showing an example of the operation of the abnormality monitoring system according to the embodiment. Note that although two terminals are illustrated in FIG. 8, the two terminals belong to different groups.

First, the monitoring device 100 generates a request at a predetermined timing (S111).

Next, the monitoring device 100 transmits the generated request to the plurality of terminals 10 (S112).

Each of the plurality of terminals 10 receives the request (S113), and generates a response to the request (S114).

Each of the plurality of terminals 10 then transmits the generated response to the monitoring device 100 (S115).

The monitoring device 100 receives a plurality of responses respectively from the plurality of terminals 10 (S116).

The monitoring device 100 calculates a throughput indicating a maximum data transfer amount in the monitoring device 100 depending on the current communication state of the monitoring device 100, based on the capacity (size) and the response time of the request transmitted to each terminal 10 and the communication information (S117).

The monitoring device 100 makes the first determination of determining whether the communication state of each of the plurality of terminals 10 is abnormal, based on the throughput, the size of the request transmitted to each of the plurality of terminals 10, and any one or more of the transfer speed, the packet loss, and the number of retransmission packets in the received response (S118).

The monitoring device 100 makes the second determination of determining whether an abnormality has occurred on the communication path between the monitoring device 100 and each of the plurality of terminals 10, based on the result of the first determination (S119).

The monitoring device 100 outputs abnormality information including the result of the second determination (S120). For example, the monitoring device 100 displays the abnormality information on the display unit 110.

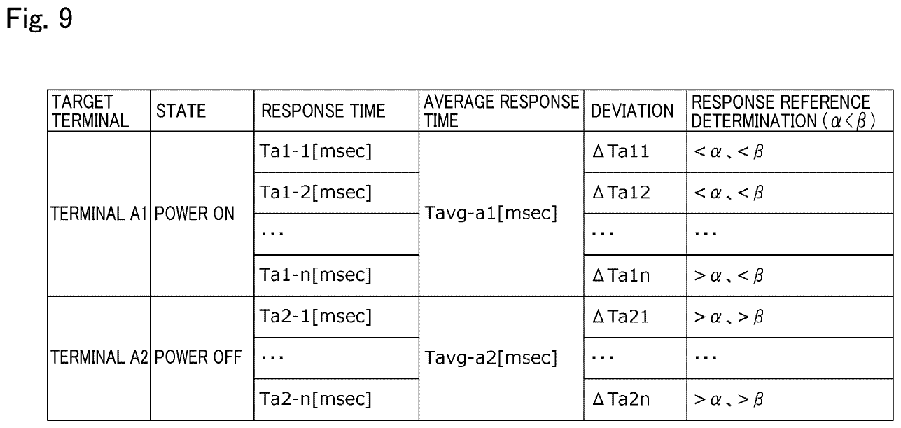

FIG. 9 is a table showing an example of the response times of the terminals and determinations using the response times. In FIG. 9, the terminals A1 and A2 are illustrated as an example.

The monitoring device 100 sequentially transmits n requests to the terminal A1, and measures a response time until n responses are received from the terminal A1 in response to the n requests. As a result, the n response times Ta1-1 to Ta1-n are obtained as illustrated in FIG. 9. The monitoring device 100 calculates an average response time Tavg-a1 based on the following formula from the n response times Ta1-1 to Ta1-n and the sizes of the requests.

$$Tavg - a 1 = \sum ( size \times response time ) / Total size$$

The monitoring device 100 calculates deviations ΔTa11 to ΔTa1n which are differences between the average response time Tavg-a1 and the response times. The monitoring device 100 then compares the deviations ΔTa11 to ΔTa1n with a threshold α and a threshold β. Note that the threshold α is smaller than the threshold β. As a result, in the example of FIG. 9, the first to (n−1)th deviations ΔTa1 to ΔTa1(n−1) are smaller than the threshold α, and the nth deviation ΔTa1n is larger than the threshold α and smaller than the threshold β. As described above, in the terminal A1, it can be seen that only the nth deviation ΔTa1n is different in tendency from the other deviations.

On the other hand, in the terminal A2, all of n deviations ΔTa21 to ΔTa2n calculated in a similar manner are larger than the threshold α and the threshold β. As a result, a determination can be made that the response is slow overall in the terminal A2.

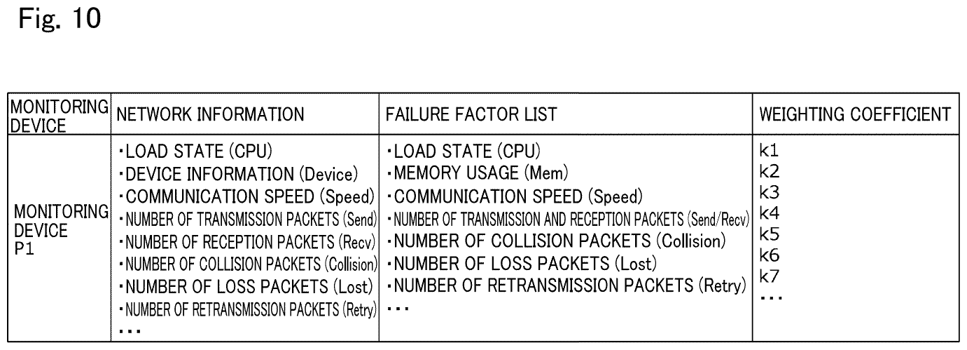

FIG. 10 is a table showing an example of information about the communication information indicating the network communication state of the monitoring device.

The communication information includes a load state (CPU), device information (Device), a communication speed (Speed), the number of transmission packets (Send), the number of reception packets (Recv), the number of collision packets (Collision), the number of lost packets (Lost), the number of retransmission packets (Retry), and the like. As a failure factor list related to the communication information, the load state (CPU), a memory usage (Mem), a communication speed (Speed), the number of transmission and reception packets (Send/Recv), the number of collision packets (Collision), the number of lost packets (Lost), the number of retransmission packets (Retry), and the like correspond to the communication information. Further, weighting coefficients k1, k2, . . . , k7 are set in the failure factor list so as to be larger for a higher degree of the failure factor. As a result, the quality of the communication state of the network can be determined based on the communication information about the monitoring device P1.

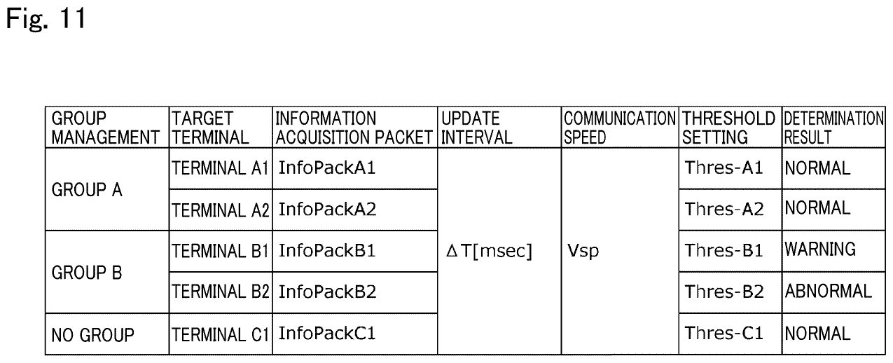

FIG. 11 is a table showing an example of determination results (results of the first determination) on whether the communication states of the terminals are abnormal.

FIG. 11 shows a state where the terminals A1, A2, B1, B2, and C1 are managed in group. The terminal A1 and the terminal A2 belong to the group A, the terminal B1 and the terminal B2 belong to the group B, and the terminal C2 is managed without group. Further, the response information about the terminals indicates InfoPackA1, InfoPackA2, InfoPackB1, InfoPackB2, and InfoPackC1. Each piece of the response information InfoPack includes an operation state, response time information, new path information, and the like. Since the response information is periodically acquired for each terminal, FIG. 11 shows an example where an update interval is ΔT msec. FIG. 11 illustrates a case where InfoPack of each terminal is acquired at ΔT msec interval, the communication speed of the network at that time is Vsp, and the calculated thresholds of the terminals A1, A2, B1, B2, and C1 necessary for stable communication are thresholds Thres-A1, Thres-A2, Thres-B1, Thres-B2, and Thres-C1. Each threshold includes two different values. In the first determination, the monitoring device 100 determines whether the response time exceeds a threshold by comparing the response time of each terminal with the threshold associated with each terminal. If the response time exceeds only the smaller threshold, a determination is made as a warning. If the response time exceeds both of the two thresholds, a determination is made as abnormal. If the response time is equal to or less than the smaller threshold, a determination is made as normal. As described above, normality, warning, and abnormality are obtained as the determination results.

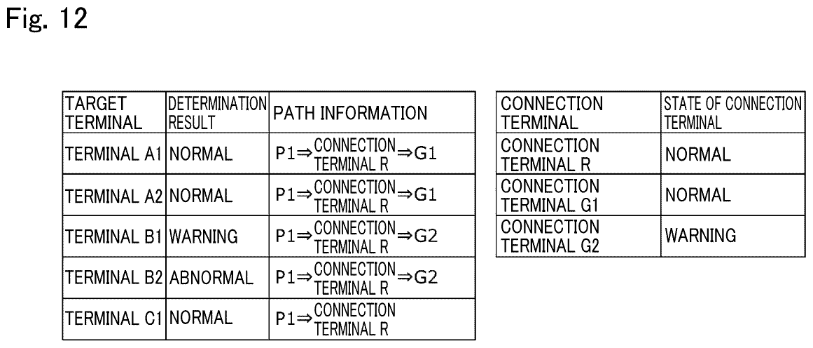

FIG. 12 is a table showing an example of determination results (results of the second determination) on whether an abnormality has occurred on the communication paths.

FIG. 12 shows the determination results of the first determination for the terminals A1, A2, B1, B2, and C1. FIG. 12 further shows the information about set paths between the monitoring device 100 and the terminals A1, A2, B1, B2, and C1. As a result of the first determination, since all of the plurality of terminals A1 and A2 belonging to the group A are normal, the monitoring device 100 determines that the communication state of the communication path “P1→connection terminal R→G1” via the connected terminal G1 is normal. As a result of the first determination, since the terminal B1 belonging to the group B is in a warning state, the terminal B2 is abnormal, and all the terminals are in a communication state at least worse than the warning state, the monitoring device 100 determines that the communication state of the communication path “P1→connection terminal R→G2” via the connection terminal G2 is in the warning state. Note that in a case where all the terminals belonging to the group are abnormal as a result of the first determination, the monitoring device 100 determines that the communication state of the communication path via the connection terminal common to the terminals in this group is abnormal. Further, since the determination results of the terminals A1 and A2 connected to the monitoring device 100 on the communication path routed through the connection terminal R are normal, the monitoring device 100 may determine that the communication state of the communication path touted through the connection terminal R is normal. On the other hand, in a case where the determination results of all the terminals connected to the monitoring device 100 on the communication path routed through the connection terminal R are abnormal, the monitoring device 100 may determine that the communication state of the communication path routed through the connection terminal R is abnormal.

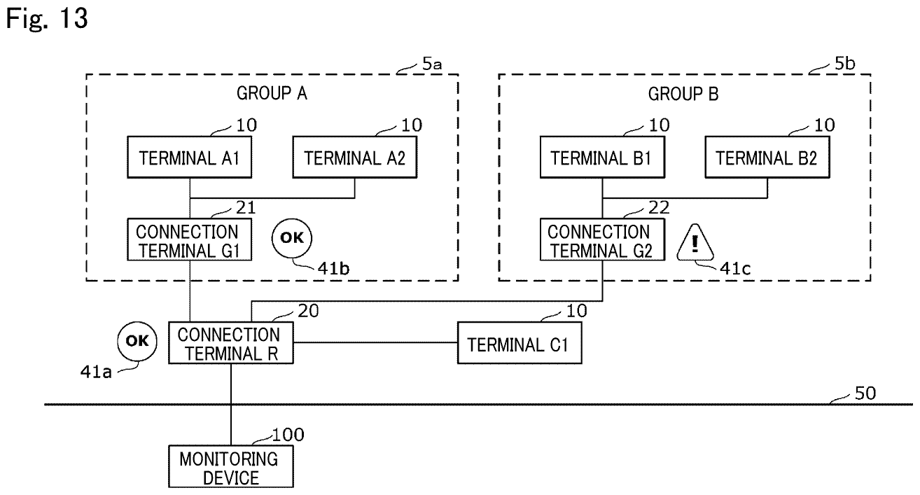

FIG. 13 is a diagram illustrating an example of the abnormality information.

The monitoring device 100 generates abnormality information indicating that the communication states of the connection terminal R and the connection terminal G1 are normal and the communication state of the connection terminal G2 is abnormal, based on the determination result of the second determination. The generated abnormality information is displayed on the display unit 110 together with a diagram schematically illustrating the monitoring device 100 through a monitoring target at the end. For example, as illustrated in FIG. 13, the abnormality information indicates marks 41a and 41b indicating normality near the normal connection terminal R and connection terminal G1, and a mark 41c indicating a warning near the connection terminal G2 in the warning state. Since it can be said that the communication state of the path between the connection terminal R and the connection terminal G2 is the warning state, the path between the connection terminal R and the connection terminal G2 may be indicated by a display mode (for example, a broken line) indicating the warning state.

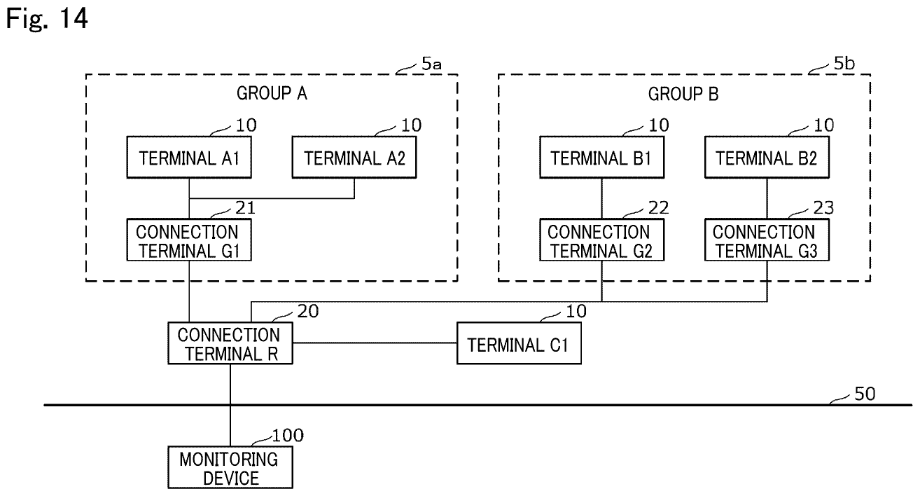

Since the communication state of the connection terminal G2 is the warning state, in order to reduce the communication load of the connection terminal G2, the connection form may be changed so that the terminals B1 and B2 connected to the connection terminal G2 are distributed to the two connection terminals G2 and G3 as illustrated in FIG. 14.

In this way, by reconstructing the network configuration, the connection terminals G2 and G3 can be disposed in consideration of the communication loads of the terminals B1 and B2, and the stabilization of the communication quality of the connection terminals G2 and G3 can be secured.

### 1-3. Effects and the Like

An abnormality monitoring method according to the present embodiment is an abnormality monitoring method for monitoring communication states of a plurality of terminals connected to a network via one or more relay devices by using a monitoring device connected to the network, the abnormality monitoring method including transmitting requests respectively to the plurality of terminals, receiving responses to the requests, calculating a throughput of the network based on transmission of the requests and reception of the responses, making a first determination of determining whether the communication states of the plurality of terminals are abnormal, based on the throughput, sizes of the requests transmitted respectively to the plurality of terminals, and any one or more of transfer speeds, packet losses, and numbers of retransmission packets in the received responses, making a second determination of determining whether an abnormality has occurred on a communication path between the monitoring device and the plurality of terminals, based on a result of the first determination, and outputting a result of the second determination.

Accordingly, the first determination is made based on the throughput, the sizes of the requests transmitted respectively to the plurality of terminals, and any one or more of the transfer speeds, the packet losses, and the numbers of retransmission packets in the received responses, and a determination is made whether an abnormality has occurred on communication paths, based on the result of the first determination. For this reason, a determination can be made more accurately whether an abnormality has occurred in terminals to be monitored or on a network.

Further, in the abnormality monitoring method according to the present embodiment, in the first determination, for each of the plurality of terminals, (i) a communication processing time required for communication processing of a packet per unit size in each terminal is estimated based on the throughput, the size of the request transmitted to each terminal, and any one or more of the transfer speed, the packet loss, and the number of retransmission packets in the response received from each terminal, and (ii) in a case where the estimated communication processing time exceeds a predetermined threshold corresponding to each terminal, a determination is made that the communication state of each terminal is abnormal.

Therefore, the determination can be made more accurately whether the communication states of the terminals are abnormal.

Further, in the abnormality monitoring method according to the present embodiment, each of the plurality of responses received by the monitoring device from the plurality of terminals includes one or more pieces of device information indicating one or more communication devices on the network, each response having passed through the one or more communication devices between the monitoring device and each terminal that has transmitted the response. The plurality of communication paths between the monitoring device and the plurality of terminals is specified by one or more pieces of device information included in the responses transmitted respectively from the terminals corresponding to the communication paths.

Accordingly, the communication paths between one or more terminals that have transmitted one or more responses and the monitoring device are specified based on one or more pieces of device information included in the one or more responses. For this reason, for example, the communication paths where an abnormality has occurred can be specified by determining whether an abnormality has occurred in the one or more communication devices.

In the abnormality monitoring method according to the present embodiment, the plurality of terminals is classified into one or more groups. The abnormality monitoring method includes, for each of the plurality of terminals, (i) acquiring, based on the response received from each of the terminals, first path information including a combination of one or more pieces of device information indicating one or more devices, the response having passed through the one or more devices between the monitoring device and each of the plurality of terminals, and (ii) generating second path information in which the first device information is added to the one or more pieces of device information in a case where the one or more pieces of device information included in the first path information include no first device information indicating a first device common to one or more terminals belonging to the group to which each terminal belongs. In the second determination, a determination is made whether an abnormality has occurred on the communication path based on the second path information.

Therefore, even in a case where the monitoring device is connected to the terminals via a relay device that is commonly connected to the plurality of terminals, a determination can be made whether an abnormality has occurred on the communication paths routed through the relay device. In this relay device, the information from the terminals includes no information routed through the relay device.

Further, in the abnormality monitoring method according to the present embodiment, the plurality of terminals includes a plurality of first terminals belonging to a first group and one or more second terminals belonging to a second group. Further, in the abnormality monitoring method, in a case where a determination is made in the second determination that an abnormality has occurred in all of the plurality of first terminals, a determination is made that an abnormality has occurred in the communication path routed through a first relay device that relays communication between the monitoring device and the plurality of first terminals.

Therefore, a determination can be made whether an abnormality has occurred on the communication paths routed through the first relay device.

In the abnormality monitoring method according to the present embodiment, the following processing may be further performed. For example, in the abnormality monitoring method, a determination may be made whether communication states of the plurality of first terminals are similar to each other, based on the sizes of the requests transmitted respectively to the plurality of terminals, and any one of the transfer speeds, the packet losses, and the numbers of retransmission packets in the received responses, and a third terminal may be excluded from the first group in a case where the plurality of first terminals includes the third terminal having a dissimilar communication state.

For example, in a case where the plurality of first terminals is classified into the same group based on connection by the common relay device, a third terminal that has been erroneously classified can be excluded from the group by using the fact that the communication states of the plurality of first terminals are similar.

Further, in the abnormality monitoring method according to the present embodiment, in the result of the second determination, one or more abnormal terminals where an abnormality has occurred are indicated in a display mode different from that of other terminals where no abnormality has occurred.

Therefore, a user can distinguish and visually recognize a terminal where an abnormality has occurred and a terminal where no abnormality has occurred. Further, the user can distinguish and visually recognize a communication path where an abnormality has occurred and a communication path where no abnormality has occurred.

Although the abnormality monitoring system, the abnormality monitoring method, and the like according to the embodiment of the present disclosure have been described above, the present disclosure is not limited to this embodiment.

Each processing unit included in the abnormality monitoring system, the monitoring device, the terminals, the connection terminals, and the like according to the above embodiment is typically implemented as a large scale integration (LSI) which is an integrated circuit. These may be individually integrated into one chip, or may be integrated into one chip so as to include some or all of them.

The circuit integration is not limited to LSI, and may be implemented by a dedicated circuit or a general-purpose processor. A field programmable gate array (FPGA) that can be programmed after manufacturing of the LSI or a reconfigurable processor where connections and settings of circuit cells inside the LSI can be reconfigured may be used.

The present disclosure may be implemented as an abnormality monitoring method or the like executed by an abnormality monitoring system, a monitoring device, a terminal, or the like.

Further, the division of the functional blocks in the block diagrams is an example, and a plurality of functional blocks may be implemented as one functional block, one functional block may be divided into a plurality of functional blocks, or some functions may be transferred to another functional block. Functions of a plurality of functional blocks having similar functions may be processed in parallel or in a time division manner by single hardware or software.

Furthermore, the order in which the steps in the flowcharts are executed is for specifically describing the present disclosure, and may be an order other than the above one. Some of the above steps may be executed simultaneously (in parallel) with other steps.

Although the abnormality monitoring system, the monitoring device, and the like according to one or more aspects have been described above based on the embodiment, the present disclosure is not limited to this embodiment. In the scope of one or more aspects, various modifications conceivable by those skilled in the art may be applied to the present embodiment, and configurations may be constructed by combining components in different embodiments without departing from the gist of the present disclosure.

What is claimed is:

1. An abnormality monitoring method for monitoring communication states of a plurality of terminals connected to a network via one or more relay devices by using a monitoring device connected to the network, the abnormality monitoring method comprising:
transmitting requests respectively to the plurality of terminals;
receiving responses to the requests;
calculating a throughput of the network based on transmission of the requests and reception of the responses;
making a first determination of determining whether the communication states of the plurality of terminals are abnormal, based on the throughput, sizes of the requests transmitted respectively to the plurality of terminals, and any one or more of transfer speeds, packet losses, and numbers of retransmission packets in the received responses;
making a second determination of determining whether an abnormality has occurred on communication paths between the monitoring device and the plurality of terminals, based on a result of the first determination; and
outputting a result of the second determination.

2. The abnormality monitoring method according to claim 1, wherein
in the first determination, for each of the plurality of terminals,
a communication processing time required for communication processing of a packet per unit size in each terminal is estimated based on the throughput, the size of the request transmitted to each terminal, and any one or more of the transfer speed, the packet loss, and the number of retransmission packets in the response received from each terminal, and
in a case where the estimated communication processing time exceeds a predetermined threshold corresponding to each terminal, a determination is made that the communication state of each terminal is abnormal.

3. The abnormality monitoring method according to claim 1, wherein
the plurality of responses received by the monitoring device respectively from the plurality of terminals includes one or more pieces of device information indicating one or more communication devices on the network, the responses having passed through the one or more communication devices between the plurality of terminals that has respectively transmitted the responses and the monitoring device, and
the plurality of communication paths between the monitoring device and the plurality of terminals is specified based on the one or more pieces of device information included in the responses transmitted respectively from the plurality of terminals respectively corresponding to the communication paths.

4. The abnormality monitoring method according to claim 1, wherein
the plurality of terminals is classified into one or more groups, the abnormality monitoring method further comprising:
for each of the plurality of terminals,
acquiring, based on the response received from each terminal, first path information including a combination of one or more pieces of device information indicating one or more devices between the monitoring device and each terminal;
generating, in a case where the one or more pieces of device information included in the first path information does not include a first device information indicating a first device common to one or more terminals belonging to the group to which each terminal belongs, second path information in which the first device information is added to the one or more pieces of device information; and
making, in the second determination, a determination whether an abnormality has occurred on the communication path based on the second path information.

5. The abnormality monitoring method according to claim 1, wherein the plurality of terminals includes a plurality of first terminals belonging to a first group and one or more second terminals belonging to a second group,
the abnormality monitoring method further comprising:
making a determination that an abnormality has occurred on communication paths routed through a first relay device that relays communication between the monitoring device and the plurality of first terminals in a case where a determination is made in the second determination that an abnormality has occurred in all of the plurality of first terminals.

6. The abnormality monitoring method according to claim 5, further comprising:
determining whether communication states of the plurality of first terminals are similar to each other, based on the sizes of the requests transmitted respectively to the plurality of terminals and any one of the transfer speeds, the packet losses, and the numbers of retransmission packets in the received responses; and
excluding a third terminal from the first group in a case where the plurality of first terminals includes the third terminal having a dissimilar communication state.

7. The abnormality monitoring method according to claim 1, wherein in the result of the second determination, one or more abnormal terminals where an abnormality has occurred are indicated in a display mode different from that of other terminals where no abnormality has occurred.

8. An abnormality monitoring system comprising:
a plurality of terminals connected to a network via one or more relay devices; and
a monitoring device that is connected to the network and monitors communication states of the plurality of terminals,
wherein the monitoring device
transmits requests respectively to the plurality of terminals,
receives responses to the requests,
calculates a throughput of the network based on transmission of the requests and reception of the responses,
makes a first determination of determining whether the communication states of the plurality of terminals are abnormal, based on the throughput, sizes of the requests transmitted respectively to the plurality of terminals, and any one or more of transfer speeds, packet losses, and numbers of retransmission packets in the received responses,
makes a second determination of determining whether an abnormality has occurred on communication paths between the monitoring device and the plurality of terminals, based on a result of the first determination, and
outputs a result of the second determination.

9. A non-transitory recording medium storing a program for causing a computer to execute the abnormality monitoring method according to claim 1.

10. An abnormality monitoring method for monitoring communication states of a plurality of terminals connected to a network via one or more relay devices by using a monitoring device connected to the network, the abnormality monitoring method comprising:
transmitting requests respectively to the plurality of terminals;
receiving responses to the requests;
making a first determination of determining whether the communication states of the plurality of terminals are abnormal, based on transmission of the requests or reception of the responses;
making a second determination of determining whether an abnormality has occurred on communication paths between the monitoring device and the plurality of terminals; and
outputting a result of the second determination.

11. A non-transitory recording medium storing a program for causing a computer to execute the abnormality monitoring method according to claim 10.
